(19) United States
(12) Patent Application Publication
(10) Pub. No.: US 2025/0174647 A1
(43) Pub. Date: May 29, 2025

(54) LITHIUM-RICH MANGANESE-BASED OXIDE AS A POSITIVE ELECTRODE ACTIVE MATERIAL FOR LITHIUM-ION RECHARGEABLE BATTERIES

(71) Applicants: Umicore, Brussels (BE); Centre National De La Recherche Scientifique, PARIS (FR); Université De Montpellier, Montpellier (FR); École Nationale Supérieure De Chimie De Montpellier, Montpellier (FR)

(72) Inventors: Jens Martin PAULSEN, Dunedin (NZ); HongNam NGUYEN, Cheonan (KR); Mikhael BECHELANY, Montpellier (FR); Cassandre LAMBOUX, Montpellier (FR)

(21) Appl. No.: 18/841,740

(22) PCT Filed: Mar. 3, 2023
(86) PCT No.: PCT/EP2023/055408

§ 371 Date: Aug. 27, 2024

(30) Foreign Application Priority Data
Mar. 3, 2022 (EP) 22290013.6

(51) Int. Cl. H01M 4/525; H01M 4/02; H01M 4/36; H01M 10/0525

(52) U.S. Cl. CPC H01M 4/525; H01M 4/364; H01M 4/366; H01M 2004/021; H01M 10/0525

(57) ABSTRACT

The present invention relates to a lithium manganese-based oxide positive electrode active material comprising an outer layer of Al for lithium-ion secondary batteries (LIBs) suitable for electric vehicle (EV) and hybrid electric vehicle (HEV) applications.

### CROSS REFERENCE TO RELATED APPLICATIONS

This application is a U.S. National Stage Application of International Patent Application No. PCT/EP2023/055408, filed on Mar. 3, 2023, which claims priority to European Patent Application No. 22290013.6, filed on Mar. 3, 2022.

### TECHNICAL FIELD

The present invention relates to a lithium manganese-based oxide positive electrode active material for lithium-ion secondary batteries (LIBs) suitable for electric vehicle (EV) and hybrid electric vehicle (HEV) applications, a method of manufacturing said positive electrode active material, a battery comprising said positive electrode active material and the use of said battery.

### BACKGROUND

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Lithium- and manganese-rich oxides are appealing in terms of safety and energy density. However, these lithium- and manganese-rich oxides must be charged above 4.5 V to reach high discharge capacities of around 250 mAh/g. This high operating potential (>4.5 V) poses serious problems for the long-term stability of these cathodes due to their unfavorable reactions with the electrolyte and dissolution of transition metals occurring at the electrode-electrolyte interface. As a result the cycle performance of the cathode material is reduced.

Therefore, there is a need to mitigate the reaction between these cathodes and electrolytes by modifying the surface of these cathodes thereby further increasing the cycle life of the cathode materials.

It is an object of the present invention to provide a positive electrode active material having one or more improved properties, such as an increased cycle life as indicated by a capacity fading rate (QF) value in an electrochemical cell.

It is a further object of the present invention to provide a method for manufacturing the positive electrode active material.

It is a further object of the present invention to provide a battery comprising the positive electrode active material.

It is a further object of the present invention to provide a use of the battery.

### SUMMARY OF THE INVENTION

This objective is achieved by providing a positive electrode active material for lithium-ion rechargeable batteries, comprising Li, M′, and oxygen, wherein M′ comprises:
Mn in a content z, wherein 40.0≤z≤90.0 mol %, relative to M′;
Ni in a content x, wherein 0.0≤x≤40.0 mol %, relative to M′;
Co in a content y, wherein 0.0≤y≤10.0 mol %, relative to M′;
M″ in a content b, wherein 0.002≤b≤10.0 mol %, relative to M′;
D in a content c, wherein 0.0≤c≤2.0 mol %, relative to M′, wherein D comprises an element other than Li, O, Ni, Co, Mn, and Al;
wherein x, y, z, b, and c are measured by ICP-OES,
wherein x+y+z+b+c is 100.0 mol %,
   wherein the positive electrode active material comprises a secondary particle comprising primary particles, wherein the primary particles comprise an outer layer comprising M″, wherein M″ is Al, Zr or a combination thereof.

The present inventors have surprisingly found that by atomic layer deposition of Al₂O₃ and/or ZrO₂, preferably Al₂O₃, on a Li-rich Mn-based oxide material, the resulting positive electrode active material has an increased cycle life as indicated by a capacity fading rate (QF) value, as demonstrated in the appended examples, thereby increasing the cycle life. The positive electrode comprising the positive electrode active material in this invention shows an improved electrochemical stability as compared to a positive electrode comprising a general manganese-based oxide due to the aluminum layer on top of the primary particles. Without wishing to be bound by any theory, the present inventors believe that by coating of the surface of the positive electrode active material the direct contact with the electrolyte is prevented, resulting in an increased cycle life of the positive electrode active material.

A further aspect of the present invention provides a method for manufacturing the positive electrode active material comprising the consecutive steps of a mixing step, a first firing step, and drying step, a second firing step and an aluminum treating step.

A further aspect of the present invention provides a battery comprising the positive electrode active material.

A further aspect of the present invention provides a use of the battery.

### BRIEF DESCRIPTION OF THE FIGURES

FIG. 1 shows the Al distribution of EX2, as measured by STEM-EDX.

FIG. 2 shows the thickness of Al layer of EX2, as measured by TEM.

FIG. 3 shows the XPS profiles of Al 2p peaks of EX2 and EX3.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. In contrast, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

A positive electrode active material is defined as a material which is electrochemically active in a positive electrode. By active material, it must be understood a material capable to capture and release Li ions when subjected to a voltage change over a predetermined period of time.

In the framework of the present invention, mol % signifies molar percentage. The mol % or “mol percent” of a given element expression of a concentration means how many percent of all atoms in the concerned compound are atoms of said element. The designation mol % is equivalent to at % or atomic percent.

### Positive Electrode Active Material

In a first aspect, the present invention provides a positive electrode active material for lithium-ion rechargeable batteries, wherein the positive electrode active material comprises Li, M′, and oxygen, wherein M′ comprises:
Mn in a content z, wherein 40.0≤z≤90.0 mol %, relative to M′;
Ni in a content x, wherein 0.0≤40.0 mol %, relative to M′;
Co in a content y, wherein 0.0≤y≤10.0 mol %, relative to M′;
M″ in a content b, wherein 0.002≤b≤10.0 mol %, relative to M′, preferably 0.2≤b≤10.0 mol %;
D in a content c, wherein 0.0≤c≤2.0 mol %, relative to M′, wherein D comprises an element other than Li, O, Ni, Co, Mn, and M″;
wherein x, y, z, b, and c are measured by ICP-OES,
wherein x+y+z+b+c is 100.0 mol %,
   wherein the positive electrode active material comprises a secondary particle comprising primary particles, wherein the primary particles comprise an outer layer comprising M″, wherein M″ is Al, Zr or a combination thereof.

A highly preferred embodiment is the positive electrode active material of the invention, wherein M″=Al.

Preferably, the Mn content z is more than 50.0 mol % relative to M′, preferably more than 60.0 mol % relative to M′, more preferably more than 70.0 mol % relative to M′. Preferably the Mn content z is less than 85.0 mol % relative to M′, preferably less than 80.0 mol % relative to M′, more preferably less than 75.0 mol % relative to M′. Preferably, the Mn content z is in the range of 50.0≤z≤85.0 mol % relative to M′, preferably in the range of 60.0≤z≤80.0 mol % relative to M′, more preferably in the range of 70.0≤z≤75.0 mol % relative to M′.

Preferably, the Co content y is less than 9.0 mol % relative to M′, preferably less than 8.0 mol % relative to M preferably less than 7.0 mol % relative to M′. Preferably the Co content y is more than 0.5 mol % relative to M′, preferably more than 1.0 mol % relative to M′, more preferably more than 1.5 mol % relative to M′. Preferably, the Co content y is in the range of 0.5≤y≤9.0 mol % relative to M′, preferably in the range of 1.0≤y≤8.0 mol % relative to M′, more preferably in the range of 1.5≤y≤7.0 mol % relative to M′.

Preferably, the Ni content x is less than 38 mol % relative to M′, preferably less than 35 mol % relative to M′, more preferably less than 30 mol % relative to M′. Preferably, the Ni content x is more than 10 mol % relative to M′, preferably more than 15 mol % relative to M′, more preferably more than 20 mol % relative to M′. Preferably, the Ni content x is in the range of 10.0≤x≤38.0 mol % relative to M′, preferably in the range of 15.0≤x≤35.0 mol % relative to M′, more preferably in the range of 20.0≤x≤30.0 mol % relative to M′.

In a preferred embodiment the content b is more than 0.6 mol % relative to M′, preferably more than 0.7 mol % relative to M′, more preferably more than 0.8 mol % relative to M′. Preferably, the Al content b is less than 9 mol % relative to M′, preferably less than 7 mol % relative to M′, more preferably less than 6 mol % relative to M′. Preferably, the Al content b is in the range of 0.6≤x≤9.0 mol % relative to M′, preferably in the range of 0.7≤x≤7.0 mol % relative to M′, more preferably in the range of 0.8≤x≤6.0 mol % relative to M′. In a highly preferred embodiment the content b is more than 0.5 mol % relative to M′, preferably more than 1.0 mol % relative to M′, more preferably more than 1.5 mol % relative to M′. Preferably, the content b is less than 5.0 mol % relative to M′, preferably less than 3.0 mol % relative to M′, more preferably less than 2.5 mol % relative to M′. Preferably, the content b is in the range of 0.5≤x≤5.0 mol % relative to M′, preferably in the range of 1≤x≤3.0 mol % relative to M′, more preferably in the range of 1.5≤x≤2.5 mol % relative to M′.

In a highly preferred embodiment M″=Al and the Al content b is more than 0.6 mol % relative to M′, preferably more than 0.7 mol % relative to M′, more preferably more than 0.8 mol % relative to M′. Preferably, the Al content b is less than 9 mol % relative to M′, preferably less than 7 mol % relative to M′, more preferably less than 6 mol % relative to M′. Preferably, the Al content b is in the range of 0.6≤x≤9.0 mol % relative to M′, preferably in the range of 0.7≤x≤7.0 mol % relative to M′, more preferably in the range of 0.8≤x≤6.0 mol % relative to M′. In a highly preferred embodiment the Al content b is more than 0.5 mol % relative to M′, preferably more than 1.0 mol % relative to M′, more preferably more than 1.5 mol % relative to M′. Preferably, the Al content b is less than 5.0 mol % relative to M′, preferably less than 3.0 mol % relative to M′, more preferably less than 2.5 mol % relative to M′. Preferably, the Al content b is in the range of 0.5≤x≤5.0 mol % relative to M′, preferably in the range of 1≤x≤3.0 mol % relative to M′, more preferably in the range of 1.5≤x≤2.5 mol % relative to M′.

In an embodiment M″=Zr and the Zr content b is more than 0.002 mol % relative to M′, preferably more than 0.003 mol % relative to M′, more preferably more than 0.0035 mol % relative to M′. Preferably, the Al content b is less than 1 mol % relative to M′, preferably less than 0.5 mol % relative to M′, more preferably less than 0.1 mol % relative to M′. Preferably, the Zr content b is in the range of 0.002≤x≤1.0 mol % relative to M′, preferably in the range of 0.003≤x≤0.5 mol % relative to M′, more preferably in the range of 0.0035≤x≤0.1 mol % relative to M′.

In a preferred embodiment D comprises at least one element of the group consisting of: Zr, B, Ba, Ca, Cr, Fe, Mg, Mo, Nb, S, Si, Sr, Ti, Y, V, W, and Zn; preferably Zr, B, Cr, Nb, S, Si, Ti, Y and W. In a more preferred embodiment D consists of at least one element of the group consisting of Zr, B, Ba, Ca, Cr, Fe, Mg, Mo, Nb, S, Si, Sr, Ti, Y, V, W, and Zn; preferably B, Cr, Nb, S, Si, Ti, Y and W.

Preferably, the D content c is more than 0.25 mol % relative to M′, preferably more than 0.5 mol % relative to M′, more preferably more than 0.75 mol % relative to M′.

Preferably, the D content c is less than 1.75 mol % relative to M′, preferably less than 1.5 mol % relative to M′, more preferably less than 1.25 mol % relative to M′. Preferably, the D content c is in the range of 0.25≤x≤1.75 mol % relative to M′, preferably in the range of 0.5≤c≤1.5 mol % relative to M′, more preferably in the range of 0.75≤c≤1.25 mol % relative to M′.

As appreciated by the skilled person the amount of Li and M′, preferably Li, Ni, Mn, Co, D and M″, preferably Al, in the positive electrode active material is measured with Inductively Coupled Plasma-Optical Emission Spectroscopy (ICP-OES). For example, but not limiting to the invention, an Agilent ICP 720-ES is used in the ICP-OES analysis.

As appreciated by the skilled person if in the definition of the invention a content of an element is stated using the symbols ‘0.0≤’ this means that the presence of said element is optional.

In a preferred embodiment the positive electrode active material has a specific surface area of more than 3.5 m²/g, preferably more than 3.7 m²/g, more preferably more than 4.0 m²/g. In a preferred embodiment the positive electrode active material has a specific surface area of less than 9.5 m²/g, preferably less than 8.5 m²/g, more preferably less than 7.5 m²/g. In a preferred embodiment the positive electrode active material has a specific surface area between 3.5 and 9.5 m²/g, preferably between 3.7 and 8.5 m²/g, more preferably between 4.0 and 7.5 m²/g. In a highly preferred embodiment the positive electrode active material has a specific surface area of more than 3.5 m²/g, preferably more than 6.5 m²/g, more preferably more than 6.8 m²/g. In a highly preferred embodiment the positive electrode active material has a specific surface area of less than 9.5 m²/g, preferably less than 9.0 m²/g, more preferably less than 8.5 m²/g. In a highly preferred embodiment the positive electrode active material has a specific surface area between 3.5 and 9.5 m²/g, preferably between 6.5 and 9.0 m²/g, more preferably 6.8 and 8.5 m²/g. As appreciated by the skilled person the specific surface area is determined by BET measurement. For example, but not limiting to the invention, the specific surface area can be determined with a Micromeritics Tristar II 3020.

In a preferred embodiment the atomic ratio of Li to M′ (Li/M′) is more than 0.5, preferably more than 1.0, more preferably more than 1.1. In a preferred embodiment the atomic ratio of Li to M′ (Li/M′) is less than 2.5, preferably less than 2.0, more preferably less than 1.6. In a preferred embodiment the atomic ratio of Li to M′ (Li/M′) is between 0.5 and 2.5, preferably between 1.0 and 2.0, more preferably between 1.1 and 1.6.

In a preferred embodiment the positive electrode active material comprises a secondary particle comprising a plurality of primary particles, wherein the primary particles comprises an outer layer comprising of Al, preferably Al₂O₃. As appreciated by the skilled person the outer layer comprising of Al is coated on the primary particles of the positive electrode active material, preferably by the method of the second aspect of the invention. As appreciated by the skilled person, the outer layer comprising of Al can be determined by STEM-EDX and/or TEM, preferably TEM.

In an embodiment the positive electrode active material comprises a secondary particle comprising a plurality of primary particles, wherein the primary particles comprises an outer layer comprising of Zr, preferably ZrO₂. As appreciated by the skilled person the outer layer comprising of Zr is coated on the primary particles of the positive electrode active material, preferably by the method of the second aspect of the invention. As appreciated by the skilled person, the outer layer comprising Zr can be determined by STEM-EDX and/or TEM, preferably TEM.

In the context of the present invention the term “outer layer comprising M”, preferably Al″ means that the primary particle has an enriched amount of M″, preferably Al, in the surface layer of the primary particle. Worded differently, the outer layer is coated comprising M″ is coated on the primary particles of the positive electrode active material. The outer layer may comprise other elements such as D resulting in an outer layer comprising M″ and D.

As appreciated by the skilled person the secondary particle comprises a plurality of primary particles, preferably more than 20 primary particles, preferably more than 10 primary particles, most preferably more than 5 primary particles. Alternatively and as appreciated by the skilled person the secondary particle comprises a plurality of primary particles, preferably more than 5 primary particles, preferably more than 10 primary particles, most preferably more than 20 primary particles.

In a preferred embodiment the thickness of the outer layer comprising M″ of the positive electrode active material is more than 0.1 nm, preferably more than 0.2 nm, more preferably more than 0.25 nm. In a preferred embodiment the thickness of the outer layer comprising M″ of the positive electrode active material is less than 10 nm, preferably less than 5.0 nm, more preferably less than 3.0 nm. In a preferred embodiment the thickness of the outer layer comprising Al of the positive electrode active material is between 0.1 and 10 nm, preferably between 0.20 and 5.0 nm, more preferably between 0.25 nm and 3.0 nm. Alternatively but equally preferred, in a preferred embodiment the thickness of the outer layer comprising M″ of the positive electrode active material is more than 0.1 nm, preferably more than 0.2 nm, more preferably more than 0.25 nm. In a preferred embodiment the thickness of the outer layer comprising M″ of the positive electrode active material is less than 3.0 nm, preferably less than 2.9 nm, more preferably less than 2.8 nm. In a preferred embodiment the thickness of the outer layer comprising Al of the positive electrode active material is between 0.1 and 3.0 nm, preferably between 0.2 and 2.9 nm, more preferably between 0.3 nm and 2.8 nm.

In a highly preferred embodiment the thickness of the outer layer comprising of Al of the positive electrode active material is more than 0.1 nm, preferably more than 0.2 nm, more preferably more than 0.25 nm. In a preferred embodiment the thickness of the outer layer comprising Al of the positive electrode active material is less than 10 nm, preferably less than 5.0 nm, more preferably less than 3.0 nm. In a preferred embodiment the thickness of the outer layer comprising Al of the positive electrode active material is between 0.1 and 10 nm, preferably between 0.20 and 5.0 nm, more preferably between 0.25 nm and 3.0 nm. Alternatively but equally preferred, in a preferred embodiment the thickness of the outer layer comprising Al of the positive electrode active material is more than 0.1 nm, preferably more than 0.2 nm, more preferably more than 0.25 nm. In a preferred embodiment the thickness of the outer layer comprising Al of the positive electrode active material is less than 3.0 nm, preferably less than 2.9 nm, more preferably less than 2.8 nm. In a preferred embodiment the thickness of the outer layer comprising Al of the positive electrode active material is between 0.1 and 3.0 nm, preferably between 0.2 and 2.9 nm, more preferably between 0.3 nm and 2.8 nm.

In a highly preferred embodiment the thickness of the outer layer comprising Al is between 0.50 and 2.50 nm, preferably between 1.50 and 2.50 nm, more preferably between 1.60 and 2.0 nm.

Typically, the thickness of the outer layer comprising of M″, preferably Al, of the positive electrode active material can be determined from a TEM image, and more in particular of TEM images of one or more primary particles having the outer layer comprising of M″, preferably Al. The TEM image may be suitably analysed using an image software analysis application program, such as imageJ software. With such an analysis tool as imageJ software the nanometric scale may be converted into a pixel scale. Typically, the thickness is determined using this tool and drawing manually two parallel lines following the two extremities of the layer. In addition a third line perpendicular to the previous ones is typically added manually. This line typically allows to measure the width of the deposit by placing a cursor that relates the number of pixels to the number of nanometers. In order to reduce the uncertainty, it is repeated 10 times at several positions on the layer. Thickness is typically indicative and rounded up to the superior value in nanometers, except when below 1 nm.

In a highly preferred embodiment the positive electrode active material of the invention an Al content Al_{A} defined as

$$\frac{b}{( x + y + z + b )} ,$$

wherein the positive electrode active material has an Al content Al_{B} wherein Al_{B} is determined by XPS analysis, wherein Al_{B} is expressed as molar fraction compared to the sum of molar fractions of Ni, Mn, Co, and Al, as measured by XPS analysis, wherein the ratio Al_{B}/Al_{A}>1, preferably Al_{B}/Al_{A}>5, preferably Al_{B}/Al_{A}>20. In a preferred embodiment the ratio Al_{B}/Al_{A}<100, preferably Al_{B}/Al_{A}<50, preferably Al_{B}/Al_{A}<30. In a preferred embodiment the ratio Al_{B}/Al_{A} is between 1 and 100, preferably between 5 and 50, more preferably between 20 and 30.

In a preferred embodiment the positive electrode active material of the invention an Zr content Zr_{A} defined as

$$\frac{b}{( x + y + z + b )} ,$$

wherein the positive electrode active material has an Zr content Zr_{B} wherein Zr_{B} is determined by XPS analysis, wherein Zr_{B} is expressed as molar fraction compared to the sum of molar fractions of Ni, Mn, Co, and Al, as measured by XPS analysis, wherein the ratio Zr_{B}/Zr_{A}>10, preferably Zr_{B}/Zr_{A}>50, preferably Zr_{B}/Zr_{A}>200. In a preferred embodiment the ratio Zr_{B}/Zr_{A}<10000, preferably Zr_{B}/Zr_{A}<8000, preferably Zr_{B}/Zr_{A}<6000. In a preferred embodiment the ratio Zr_{B}/Zr_{A} is between 10 and 10000, preferably between 50 and 8000, more preferably between 200 and 6000.

### Method for Manufacturing

In a second aspect, the present invention is also inclusive of a process for manufacturing the positive electrode active material, comprising the steps of:
Step 0) optional precursor roasting step: optionally roasting of a manganese-based transition metal carbonate in an O₂ atmosphere or dry air at a temperature between 350 and 450° C. for 1 to 20 hours;
Step 1) mixing step: mixing a manganese-based transition metal carbonate, preferably the roasted manganese-based transition metal carbonate from Step 0), homogeneously with a lithium source affording a mixture;
Step 2) first firing step: firing the mixture from Step 1) at a temperature between 750° C. and 900° C. affording a first-fired material;
Step 3) second firing step: firing the material from Step 2) at a temperature between 650° C. and 750° C. affording a double-fired material; and
Step 4) aluminum treating step: treating the double-fired material from Step 3) with an Al source or a Zr source, preferably an Al source, by an atomic layer deposition reaction so as to obtain the positive electrode active material.

In a preferred embodiment of the method, the manganese-based transition metal carbonate is a carbonate compound comprising more than 40.0 mol % manganese with respect to the major elements such as nickel, cobalt, and aluminum.

In a preferred embodiment of the method, the Li-source is lithium hydroxide, lithium carbonate, lithium sulfate, or a combination thereof.

In a preferred embodiment of the method, wherein in Step 1), the lithium source is added in an atomic ratio with respect to the manganese-based transition metal carbonate so that the Li to M′ (Li/M′) is more than 0.5, preferably more than 1.0, more preferably more than 1.1. In a preferred embodiment the atomic ratio of Li to M′ (Li/M′) is less than 2.5, preferably less than 2.0, more preferably less than 1.6. In a preferred embodiment the atomic ratio of Li to M′ (Li/M′) is between 0.5 and 2.5, preferably between 1.0 and 2.0, more preferably between 1.1 and 1.6.

As appreciated by the skilled person the homogeneously mixing of the manganese-based transition metal composition with the lithium source is a dry mixing of the manganese-based transition metal composition in the form of a powder with the lithium source in the form of a powder, wherein the mixing afforded in Step 1) is essentially free of liquids, such as less than 5 wt. % of a liquid based on the total weight of the mixture, preferably less than 2.5 wt. %, more preferably less than 1 wt. %.

In a preferred embodiment of the method, wherein in Step 2), the firing temperature is between 780° C. and 850° C., preferably between 785° C. and 825° C., more preferably between 790° C. and 810° C. In a preferred embodiment of the method, wherein in Step 2), the firing time is between 1 hour and 100 hours, preferably between 5 hours and 20 hours, more preferably between 8 hours and 14 hours.

In a preferred embodiment of the method, wherein in Step 3), the firing temperature is between 675° C. and 725° C., preferably between 680° C. and 720° C., more preferably between 690° C. and 710° C. In a preferred embodiment of the method, wherein in Step 4), the firing time is between 1 hour and 100 hours, preferably between 5 hours and 20 hours, more preferably between 8 hours and 14 hours.

In a preferred embodiment of the method an atomic layer deposition (ALD) reaction in Step 4) is implemented to form an outer layer comprising Al on the top of the primary particles. The ALD utilizes consecutive reactions of an Al source, preferably the Al source is tris(diethylamino)aluminum (TDEAA), aluminum triisopropoxide, trimethyl aluminum (TMA), aluminum ethoxide, isopropoxydimethylaluminium, tris(dimethylamido)aluminum, hexakis(dimethylamino)dialuminium or combination thereof, preferably trimethyl aluminum (TMA); with H₂O. In a preferred embodiment of the invention the ALD is implemented at a temperature between 50° C. and 250° C., preferably between 75° C. and 175° C., more preferably between 100° C. and 150° C. In a preferred embodiment of the invention the ALD is implemented under an atmosphere comprising or consisting of an inert gas, preferably the inert gas is Ar.

In a preferred embodiment of the method the ALD reaction occurs through the injection pulse of the Al source between 1 s and 60 s, preferably between 10 s and 30 s, preferably between 15 s and 25 s and under a pressure between 10 mbar and 1000 mbar, preferably between 25 mbar and 100 mbar, more preferably between 40 and 80 mbar. In a preferred embodiment of the method the exposure time of the Al source and H₂O is between 1 s and 150 s, preferably between 25 s and 100 s, most preferably between 50 s and 70 s. As appreciated by the skilled person Step 5) of the method of the invention can be repeated a number times (i.e. cycles) to increase the thickness of the outer layer comprising Al. In a preferred embodiment of the method the ALD reaction of Step 5) occurs for a number of cycles, such as 1 to 50 cycles, preferably 2 to 30 cycles, more preferably 8 to 14 cycles. The inventors have surprisingly found that through several repeats of this reaction, the Al layer could be formed in an intentional incremental thickness on the top of the primary particles composing the positive electrode active material resulting in a positive electrode active material having an increased cycle life as indicated by a capacity fading rate (QF) value. As appreciated by the skilled person atomic layer deposition is a well-known coating technology to produce highly uniform thin films (Ritala M., et al., Chem. Vap. Deposition 5, 7 (1999)).

In a preferred embodiment of the method an atomic layer deposition (ALD) reaction in Step 4) is implemented to form an outer layer comprising Zr on the top of the primary particles. The ALD utilizes consecutive reactions of a Zr source, preferably the Zr source is tetrakis(dimethylamido)zirconium (IV), zirconium 2-methyl 2-butoxide, tetrakis(diethylamido)zirconium (IV), tetrakis(ethylmethylamido)zirconium (IV) or combination thereof, preferably tetrakis(dimethylamido)zirconium (IV) (TDMAZ); with H₂O. In a preferred embodiment of the invention the ALD is implemented at a temperature between 50° C. and 250° C., preferably between 75° C. and 175° C., more preferably between 100° C. and 150° C. In a preferred embodiment of the invention the ALD is implemented under an atmosphere comprising or consisting of an inert gas, preferably the inert gas is Ar. In a preferred embodiment of the method the ALD reaction occurs through the injection pulse of the Zr source between 1 s and 60 s, preferably between 5 s and 30 s, preferably between 10 s and 25 s and under a pressure between 10 mbar and 1000 mbar, preferably between 20 mbar and 100 mbar, more preferably between 25 and 40 mbar. In a preferred embodiment of the method the exposure time of the Zr source and H₂O is between 1 s and 150 s, preferably between 25 s and 100 s, most preferably between 50 s and 70 s. As appreciated by the skilled person Step 5) of the method of the invention can be repeated a number times (i.e. cycles) to increase the thickness of the outer layer comprising Zr. In a preferred embodiment of the method the ALD reaction of Step 5) occurs for a number of cycles, such as 1 to 50 cycles, preferably 2 to 30 cycles, more preferably 8 to 14 cycles. The inventors have surprisingly found that through several repeats of this reaction, the Zr layer could be formed in an intentional incremental thickness on the top of the primary particles composing the positive electrode active material resulting in a positive electrode active material having an increased cycle life as indicated by a capacity fading rate (QF) value. As appreciated by the skilled person atomic layer deposition is a well-known coating technology to produce highly uniform thin films (Ritala M., et al., Chem. Vap. Deposition 5, 7 (1999)).

In a highly preferred embodiment the positive electrode active material obtained in Step 4) is the positive electrode active material according to the first aspect of the invention.

### Battery

In a third aspect the present invention concerns a battery comprising the positive electrode active material according to the first aspect of the invention.

In a preferred embodiment the battery is a lithium-ion battery, preferably a lithium-ion rechargeable battery. Preferably the battery comprises a positive electrode comprising the positive electrode active material according to the first aspect of the invention, a negative electrode, an electrode, and a separator.

In a preferred embodiment the battery according to the invention has a capacity fading rate (QF) off less than 30% per 100 cycles, preferably less than 25% per 100 cycles, more preferably less than 15% per 100 cycles. As appreciated by the skilled person the capacity fading rate is determined as explained under point C2) of the Examples.

### Use

In a fourth aspect the present invention concerns a use of the positive electrode active material according to the first aspect of the invention in a battery.

A preferred embodiment is the use of the positive electrode active material in a battery, preferably the battery according to the third aspect of the invention, to increase the efficiency of the battery.

In a fifth aspect the present invention concerns a use of the battery according to the third aspect of the invention in either one of a portable computer, a tablet, a mobile phone, an energy storage system, an electric vehicle or in a hybrid electric vehicle, preferably in an electric vehicle or in a hybrid electric vehicle.

### EXAMPLES

### A) Inductively Coupled Plasma Optical Emission Spectrometry (ICP-OES) Analysis

The amount of Li, Ni, Mn, Co, Al and Zr in the positive electrode active material powder is measured with the Inductively Coupled Plasma Optical Emission Spectrometry (ICP-OES) method by using an Agillent ICP 720-OES. 2 grams of powder sample is dissolved into 10 mL of high purity hydrochloric acid (at least 37 wt % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 ml mark, followed by complete homogenization. An appropriate amount of solution is taken out by pipette and transferred into a 250 mL volumetric flask for the 2nd dilution, where the volumetric flask is filled with internal standard and 10% hydrochloric acid up to the 250 mL mark and then homogenized. Finally, this 50 mL solution is used for ICP measurement.

### B) Surface Area Analysis

The specific surface area of the positive electrode active material is measured with the Bruanauer-Emmett-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77K. By obtaining the nitrogen isothermal absorption/desorption curve, the total specific surface area of the sample in m²/g is derived.

### C) Scanning Transmission Electron Microscopy (STEM) and Energy Dispersive X-ray Spectroscopy (EDS) analysis

The electron microscopic images were measured with the Scanning Transmission Electron Microscopy (STEM) and Energy Dispersive X-ray Spectroscopy (EDS) after making a lamella from a particle by ultramicrotome so as to obtain the cross-sectional image. The cross-sectional TEM lamellas of particles having 70 nm thickness are prepared by Ultramicrotome LEICA UC 7. The TEM and STEM were measured with JEM-ARM200F cold FEG using a cold type field emission source, wherein the TEM imaging resolution is 1.9 Å point and 1.0 Å line while the STEM imaging resolution is 0.78 Å using HAADF JEOL, BF JEOL, HAADF GATAN, and BF/DF GATAN as STEM detectors. The elemental distribution was detected by EDS with SDD CENTURIO-X and by EELS with GATAN GIF QUANTUM ER spectrometer.

### D) X-ray Photoelectron Spectroscopy (XPS) Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e., surface layer. Therefore, all elements measured by XPS are contained in the surface layer.

For the surface analysis of positive electrode active material powder particles, XPS measurement is carried out using a Kratos Axis Ultra DLD spectrometer. Monochromatic Al Kα radiation (hu=1486.6 eV) is used. A wide survey scan to identify elements present at the surface is conducted and accurate narrow scans are performed afterwards for each identified element to determine the precise surface composition. C1s peak having a maximum intensity (or centered) at a binding energy of 284.65 eV is used as a calibrate peak position after data collection.

Curve fitting is done with CasaXPS Version2.3.19PR1.0 using a Shirley-type background treatment and Scofield sensitivity factors. The fitting parameters are according to Table 1a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 1a
XPS fitting parameter for Ni2p3, Mn2p3, Co2p3, Al2p, and Zr3d

| | Sensitivity | Fitting range | | |
|---|---|---|---|---|
| Element | factor | (eV) | Defined peak(s) | Line shape |
| Ni | 14.61 | 851.1 ± 0.1- | Ni2p3, Ni2p3 satellite | LA(1.33, |
| | | 868.7 ± 0.1 | | 2.44, 69) |
| Mn | 9.17 | 639.9 ± 0.1- | Mn2p3 peak1, Mn2p3 | GL(30) |
| | | 650.2 ± 0.1 | peak2, Mn2p3 peak1 | |
| | | | satellite, and Mn2p3 | |
| | | | peak 2 satellite | |
| Co | 12.62 | 775.4 ± 0.1- | Co2p3, Co2p3 satellite | LA(1.33, |
| | | 791.6 ± 0.3 | | 2.44, 69) |
| Al | 0.54 | 78.7 ± 0.1- | Al2p peak | GL(30) |
| | | 70.5 ± 0.1 | | |
| Zr | 7.04 | 179.7 ± 0.1- | Zr3d peak 1, Zr3d | GL(30) |
| | | 187.5 ± 0.1 | peak 2 | |

For Mn and Co peaks, constraints are set for each defined peak according to Table 1b. All Ni3p peak related is not quantified.

TABLE 1b
XPS fitting constraints for Mn2p and Co2p peak fitting.

| | | Fitting range | FWHM | |
|---|---|---|---|---|
| Element | Defined peak | (eV) | (eV) | Area |
| Mn | Mn2p3 peak 1 | 640-642 | 0.1-3.5 | No constraint set |
| | Mn2p3 peak 2 | 642-644 | 0.1-3.5 | No constraint set |
| | Mn2p3 peak 1 | 644-646 | 0.1-3.5 | 40% of Mn2p3 peak 1 |
| | satellite | | | area |
| | Mn2p3 peak 2 | 645-650 | 0.1-3.5 | 40% of Mn2p3 peak 2 |
| | satellite | | | area |
| Co | Co2p3 | 778.0-782.0 | 0.5-4.0 | No constraint set |
| | Co2p3 satellite | 789.0-792.0 | 0.5-4.0 | No constraint set |

The Al surface contents or the Zr surface contents as determined by XPS are expressed as atomic fractions of Al or Zr in the surface layer of the particles divided by the total content of Ni, Mn, Co, Al, and Zr in said surface layer. It is calculated as follows:

$$atomic ratio of Al to Ni , Mn , Co , Al , \\ and Zr by XPS = \frac{Al ( at . \% )}{Ni + Mn + Co + Al + Zr ( at . \% )} \\ atomic ratio of Zr to Ni , Mn , Co , Al , \\ and Zr by XPS = \frac{Zr ( at . \% )}{Ni + Mn + Co + Al + Zr ( at . \% )}$$

### E) Coin Cell Testing

### E1) Coin Cell Preparation

For the preparation of a positive electrode, a slurry that contains a positive electrode active material powder, conductor (Super P, Timcal), binder (KF #9305, Kureha)—with a formulation of 83:8.0:8.0 by weight—in a solvent (NMP, Mitsubishi) is prepared by a high-speed homogenizer. The homogenized slurry is spread on one side of an aluminum foil using a doctor blade coater with a 230 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### E2) Testing Method

The testing method is a conventional “constant cut-off voltage” test. The conventional coin cell test in the present invention follows the schedule shown in Table 2. Each cell is cycled at 25° C. using a Toscat-3100 computer-controlled galvanostatic cycling station (from Toyo).

The schedule uses a 1C current definition of 160 mA/g in the 4.6 V to 2.0 V/Li metal window range. The capacity fading rate (QF) is obtained according to below equation.

$$QF ( \% / cycle ) = ( 1 - \frac{{DQ}_{31}}{{DQ}_{8}} ) \times \frac{1}{23} \times 100$$

wherein DQ1 is the discharge capacity at the first cycle, DQ8 is the discharge capacity at the 8th cycle, and DQ31 is the discharge capacity at the 31st cycle.

TABLE 2
Cycling schedule for Coin cell testing method

| | Charge | | | | Discharge | | | |
|---|---|---|---|---|---|---|---|---|
| | | | | V/Li | | | | V/Li |
| | | End | Rest | metal | | End | Rest | metal |
| Cycle | C Rate | current | (min) | (V) | C Rate | current | (min) | (V) |
| 1 | 0.05 | — | 30 | 4.6 | 0.05 | — | 30 | 2.0 |
| 2 | 0.25 | 0.05 C | 10 | 4.6 | 0.10 | — | 10 | 2.0 |
| 3 | 0.25 | 0.05 C | 10 | 4.6 | 0.20 | — | 10 | 2.0 |
| 4 | 0.25 | 0.05 C | 10 | 4.6 | 0.50 | — | 10 | 2.0 |
| 5 | 0.25 | 0.05 C | 10 | 4.6 | 1.00 | — | 10 | 2.0 |
| 6 | 0.25 | 0.05 C | 10 | 4.6 | 2.00 | — | 10 | 2.0 |
| 7 | 0.25 | 0.05 C | 10 | 4.6 | 3.00 | — | 10 | 2.0 |
| 8 | 0.25 | 0.05 C | 10 | 4.6 | 0.10 | — | 10 | 2.0 |
| 9 | 0.25 | 0.05 C | 10 | 4.6 | 1.00 | — | 10 | 2.0 |
| 10-30 | 0.25 | 0.05 C | 10 | 4.6 | 0.50 | — | 10 | 2.0 |
| 31 | 0.25 | 0.05 C | 10 | 4.6 | 0.10 | — | 10 | 2.0 |
| 32 | 0.25 | 0.05 C | 10 | 4.6 | 1.00 | — | 10 | 2.0 |

The invention is further illustrated by the following (non-limitative) examples:

### Comparative Example 1

A CEX1 is prepared according to the following process.
1) Precursor roasting step: a Mn-based transition metal carbonate precursor with metal composition of Ni_{0.27}Co_{0.02}Mn_{0.71} is roasted in an O₂ atmosphere at 400° C. for 10 hours by the heating rate is 5° C./min and cooled to room temperature naturally.
2) First mixing step: 100 grams of the roasted Mn-based transition metal carbonate, 4.16 grams of Li₂SO₄, and 41.77 grams of Li₂CO₃ are homogeneously mixed in an industrial blending equipment so that a molar ratio of Li to metal M′ (Li/M′) is 1.40 wherein M′ is a total molar content of Ni, Mn, and Co.
3) First firing step: the first mixture from step 2) is fired in a dry air atmosphere at 600° C. for 12 hours and cooled to room temperature naturally wherein the heating rate to 500° C. is 5° C./min and the next heating rate to 600° C. is 1° C./min.
4) Second mixing step: 100 grams of the first fired material and 2.65 grams of Li₂CO₃ are homogeneously mixed so that a molar ratio of Li to metal M″ (Li/M″) is 1.47 wherein M″ is a total molar content of Ni, Mn, and Co.
5) Second firing step: the second mixture from step 4) is fired in a dry air atmosphere at 800° C. for 10 hours by the heating rate is 1.5° C./min and cooled to room temperature naturally. The second fired material has a Na content of 0.60 wt. % and a S content of 1.29 wt. % with respect to the total weight of the second fired material.
6) Third firing step: the dried material from Step 5) is fired under a dry air atmosphere at 700° C. for 10 hours so as to obtain a lithium-rich Mn-based transition metal oxide material. The fired powder is labelled as CEX1.

### Comparative Example 2

A CEX2 is prepared according to the following process.
1) Mixing step: a lithium-rich Mn-based oxide material CEX1 is homogeneously mixed with 0.38 wt. % of Al₂O₃ with respect to the total transition metal amount of CEX1 powder.
2) Heating step: the mixture from Step 1) is heated under a dry air atmosphere at 375° C. for 10 hours and cooled naturally to room temperature. The heated powder is labelled as CEX2.

### Example 1˜Example 3

A positive electrode active material comprising primary particles having an Al₂O₃ layer on the top is prepared by atomic layer deposition (ALD) reaction with a lithium-rich Mn-based oxide material CEX1 (10 g) using trimethylaluminum (TMA) as an aluminum source. ALD is implemented at 100-150° C. under Ar flowing atmosphere. TMA injection pulse is 20 seconds dose to 50 mbar pressure and H₂O injection pulse is 15 seconds dose to 50 mbar pressure. The total exposure time of TMA and H₂O is 60 seconds. Al₂O₃ deposited positive electrode active materials EX1, EX2, and EX3 are obtained after 6 cycles, 12 cycles, and 25 cycles of ALD, respectively.

Table 3 summarizes the chemical formula, Al treating methods, Al layer thickness, BET values, and electrochemical properties.

### Example 4 and Example 5

A positive electrode active material comprising primary particles having a ZrO₂ layer on the top is prepared by atomic layer deposition (ALD) reaction with a lithium-rich Mn-based oxide material CEX1 using tetrakis(dimethylamido)zirconium(IV) (TDMAZ) as a zirconium source. ALD is implemented with 2 grams of CEX1 at 200° C. under Ar flowing atmosphere. TDMAZ injection pulse is 3 times of 5 seconds dose to 30 mbar pressure and H₂O injection pulse is 3 times of 2 seconds dose to 30 mbar pressure. The total exposure time of TDMAZ and H₂O is 16 minutes each, same for purge time. ZrO₂ deposited positive electrode active materials EX4 and EX5 are obtained after 5 cycles and 10 cycles of ALD, respectively.

Table 4 summarizes the chemical formula, Al layer thickness, BET values, and electrochemical properties.

### Comparative Example 3

A CEX3 is prepared according to the same method as EX2 except that the second fired material is fired at 1100° C. in step 6) of preparing method of CEX1.

Table 5 summarizes the specific surface area and the electrochemical properties of EX2 and CEX3.

TABLE 3
A summary of the chemical formula, Al treating methods, Al
layer thickness, BET values, and electrochemical properties

| | | | | | Specific | |
|---|---|---|---|---|---|---|
| | | | | Al layer | surface | QF |
| Example | | | | thickness | area | (%/ |
| ID | Al_{A}* | Al_{B}** | Al_{B}/Al_{A} | (nm) | (m²/g) | cycle) |
| CEX1 | 0.0000 | n/a | n/a*** | n/a | 6.60 | 38.8 |
| CEX2 | 0.0037 | n/a | n/a | n/a | 6.99 | 303.8 |
| EX1 | 0.0027 | n/a | n/a | 0.50 | 6.92 | 21.2 |
| EX2 | 0.0190 | 0.51 | 27.4 | 1.70 | 7.10 | 11.1 |
| EX3 | 0.1000 | 0.64 | 6.3 | 2.50 | 6.71 | 15.1 |

*Al_{A} is the atomic ratio of Al to the sum of Ni, Mn, Co, and Al measured by ICP-OES
**Al_{B} is the atomic ratio of Al to the sum of Ni, Mn, Co, and Al measured by XPS
***n/a: not available

TABLE 4
A summary of the chemical formula, Zr treating methods, Zr
layer thickness, BET values, and electrochemical properties

| | | | | | Specific | |
|---|---|---|---|---|---|---|
| | | | | Zr layer | surface | |
| Example | | | | thickness | area | QF |
| ID | Zr_{A} | Zr_{B} | Zr_{B}/Zr_{A} | (nm) | (m²/g) | (%/cycle) |
| EX4 | 0.000039 | 0.21 | 5384.6 | 1.00 | 6.40 | 22.78 |
| EX5 | 0.00023 | 0.23 | 1000.0 | 4.00 | 6.49 | 28.59 |

TABLE 5
A summary of the specific surface area and
electrochemical properties of EX2 and CEX3.

| | Specific | | |
|---|---|---|---|
| | surface area | DQ2 | DQ8 |
| Example ID | (m²/g) | (mAh/g) | (mAh/g) |
| CEX3 | 0.94 | 206.1 | 213.1 |
| EX2 | 7.10 | 240.6 | 256.2 |

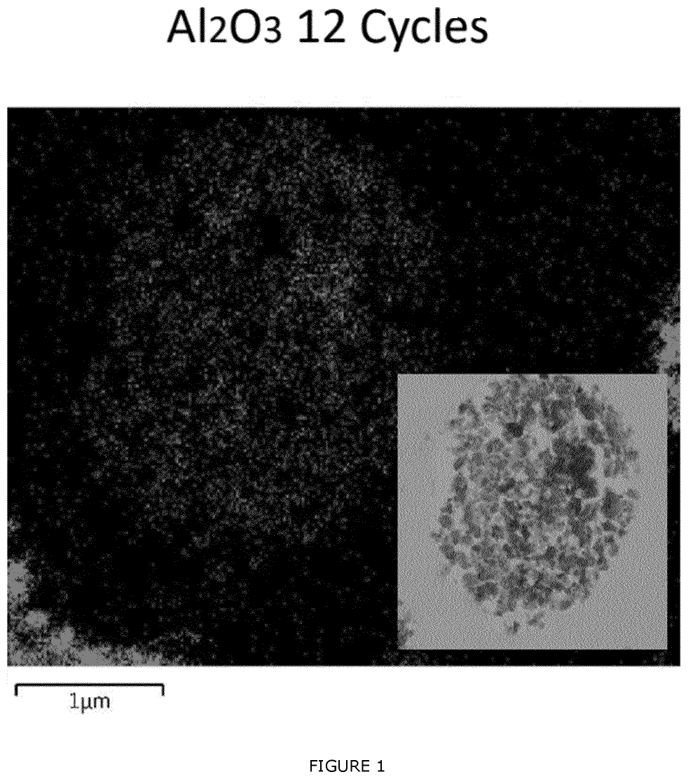

FIG. 1 shows the cross section of EX2 and the distribution of Al in EX2. It is clearly observed that Al is well distributed in a secondary particle of EX2 indicated that Al covers not only the surface of the secondary particle but also the surface of the primary particle.

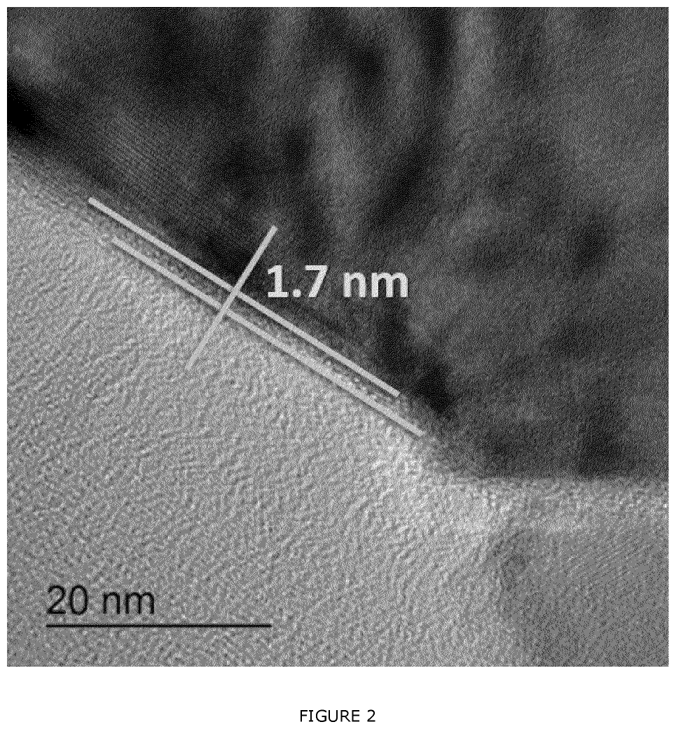

FIG. 2 shows the cross section of EX2 and the Al outer layer of a primary particle. The thickness of the Al layer can be measured using the imageJ software. With this tool the nanometric scale is converted into a pixel scale. Two parallel lines are drawn following the two extremities of the layer. In addition a third line perpendicular to the previous ones is added. This line allows to measure the width of the deposit by placing a cursor that relates the number of pixels to the number of nanometers.

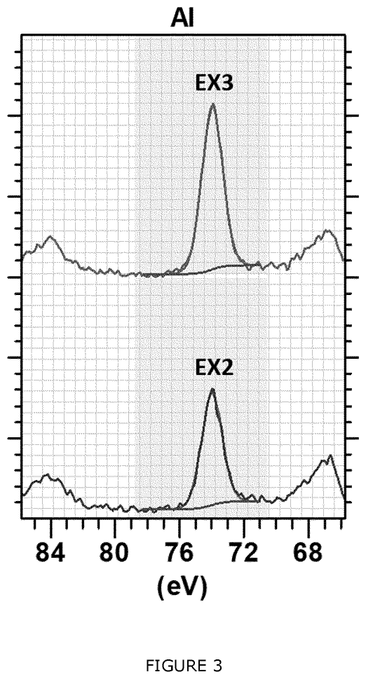

FIG. 3 shows the XPS profiles of Al 2p peaks of EX2 and EX3. The Al 2p peak positions of EX2 and EX3 are 74.00 eV and 73.97 eV, respectively. According to “Handbook of XPS, 1992, Moulder, J. F.”, it can be assumed that the Al in EX2 and EX3 exists as an Al₂O₃ form.

CEX1 is a lithium-rich Mn-based transition metal oxide material and CEX2 is a lithium-rich Mn-based transition metal oxide material which is Al treated by conventional dry coating process. With respect to the physical properties, CEX1 and CEX2 have a high specific surface area such as 6.60 m²/g and 6.99 m²/g respectively. However, CEX1 shows a capacity fading rate (QF) higher than 35%/100 cycles and CEX2 shows QF much higher than 300%/100 cycles, which represents a poor electrochemical stability. EX1, EX2, and EX3, having the features of a positive electrode material according to the present invention, result in the material having an improved QF of at most 21%/100 cycles in the electrochemical cell.

The positive electrode active materials EX4 and EX5 comprising Zr have the specific surface area of 6.40 m²/g and 6.49 m²/g respectively. The Zr_{B}/Zr_{A} value of EX4 is 5384.6 and the Zr_{B}/Zr_{A} value of EX5 is 1000.0, which represents the Zr presence on the surface of the secondary particle is higher than the Zr content in the center of the secondary particle. EX4 and EX5 show the capacity fading rate (QF) as 22.78% and 28.59% respectively, which represents the improved QF comparing to CEX1 having 38.8% as the QF.

CEX3 is a lithium-rich Mn-based transition metal oxide material with the ALD coating but a specific surface area of 0.94 m²/g, which results in poor electrochemical properties. DQ2 of CEX3 is 206.1 mAh/g which is much lower than the DQ2 of EX2 as 240.6 mAh/g.

1-15. (canceled)

16. A positive electrode active material for lithium-ion rechargeable batteries, wherein the positive electrode active material comprises Li, M′, and oxygen, wherein M′ comprises:
Mn in a content z, wherein 40.0≤z≤90.0 mol %, relative to M′;
Ni in a content x, wherein 0.0≤x≤40.0 mol %, relative to M′;
Co in a content y, wherein 0.0≤y≤10.0 mol %, relative to M′;
M″ in a content b, wherein 0.002≤b≤10.0 mol %, relative to M′;
D in a content c, wherein 0.0≤c≤2.0 mol %, relative to M′, wherein D comprises an element other than Li, O, Ni, Co, Mn, and M″;
wherein x, y, z, b, and c are measured by ICP-OES,
wherein x+y+z+b+c is 100.0 mol %,
wherein the positive electrode active material has a specific surface area between 3.5 and 9.5 m²/g,
wherein the positive electrode active material comprises a secondary particle comprising primary particles, wherein the primary particles comprise an outer layer comprising M″, wherein M″ is Al, Zr or a combination thereof.

17. The positive electrode active material according to claim 16, wherein the atomic ratio of Li to M′ (Li/M′) is between 0.5 and 2.5.

18. The positive electrode active material according to claim 16, wherein M″ is Al.

19. The positive electrode active material according to claim 18, wherein the positive electrode active material has an Al content Al_{A} defined as b/(x+y+z+b), and wherein the positive electrode active material has an Al content Al_{B} determined by XPS analysis, wherein Al_{B} is expressed as molar fraction compared to the sum of molar fractions of Ni, Mn, Co, and Al, as measured by XPS analysis, wherein the ratio Al_{B}/Al_{A}>1.

20. The positive electrode active material according to claim 16, wherein D comprises at least one element selected from the group consisting of Zr, B, Ba, Ca, Cr, Fe, Mg, Mo, Nb, S, Si, Sr, Ti, Y, V, W, and Zn.

21. The positive electrode active material according to claim 16, wherein a thickness of said outer layer is between 0.1 nm and 10.0 nm.

22. The positive electrode active material according to claim 16, wherein said Mn content z is more than 50.0 mol % relative to M′.

23. The positive electrode active material according to claim 16, wherein said Co content y is less than 9.0 mol % relative to M′.

24. The positive electrode active material according to claim 16, wherein said Al content b is more than 0.6 mol % relative to M′.

25. A method for manufacturing a positive electrode active material wherein said method comprises the following consecutive steps of:
Step 1) mixing a manganese-based transition metal carbonate homogeneously with a lithium source affording a mixture;
Step 2) firing the mixture from Step 1) at a temperature between 750° C. and 900° C. affording a first-fired material;
Step 3) firing the first-fired material from Step 2) at a temperature between 650° C. and 750° C. affording a double-fired material; and
Step 4) treating the double-fired material from Step 3) with an Al source or a Zr source, by an atomic layer deposition reaction so as to obtain the positive electrode active material.

26. The method according to claim 25, wherein the manganese-based transition metal carbonate of Step 1) is first submitted to a roasting step.

27. The method according to claim 25, wherein the positive electrode active material is a positive electrode active material for lithium-ion rechargeable batteries, wherein the positive electrode active material comprises Li, M′, and oxygen, wherein M′ comprises:
Mn in a content z, wherein 40.0≤z≤90.0 mol %, relative to M′;
Ni in a content x, wherein 0.0≤x≤40.0 mol %, relative to M′;
Co in a content y, wherein 0.0≤y≤10.0 mol %, relative to M′;
M″ in a content b, wherein 0.002≤b≤10.0 mol %, relative to M′;
D in a content c, wherein 0.0≤c≤2.0 mol %, relative to M′, wherein D comprises an element other than Li, O, Ni, Co, Mn, and M″;
wherein x, y, z, b, and c are measured by ICP-OES,
wherein x+y+z+b+c is 100.0 mol %,
wherein the positive electrode active material has a specific surface area between 3.5 and 9.5 m²/g,
wherein the positive electrode active material comprises a secondary particle comprising primary particles, wherein the primary particles comprise an outer layer comprising M″, wherein M″ is Al, Zr or a combination thereof.

28. A battery comprising the positive electrode active material according to claim 16.

29. The battery according to claim 28, wherein the battery is a lithium-ion rechargeable battery.
